(19) United States
(12) Patent Application Publication
(10) Pub. No.: US 2012/0005324 A1
(43) Pub. Date: Jan. 5, 2012

(54) Method and System for Operations Management in a Telecommunications Terminal

(75) Inventors: Eduardo Villoslada de la Torre, Valladolid (ES); Javier Martinez Elicegui, Salamanca (ES); Pedro José Ortega Barrado, Madrid (ES)

(73) Assignee: TELEFONICA, S.A., Madrid (ES)

(21) Appl. No.: 12/969,880

(22) Filed: Dec. 16, 2010

Related U.S. Application Data
(60) Provisional application No. 61/310,770, filed on Mar. 5, 2010.

(51) Int. Cl. G06F 15/173

(52) U.S. Cl. 709/223

(57) ABSTRACT

A method for managing an operation in a service terminal through a remote server, wherein said service terminal comprises a plurality of modules, and a communications interface configured for communicating with said remote server, wherein said remote server comprises a plurality of applications and a communications interface. The method comprises the following steps: generating an event as a response to a user interaction with one of said modules of the service terminal; associating an information to said event; sending said information to the remote server through said communications interface; processing said received information in the remote server and running an application which obtains a response to the information associated to said event; sending said response to the service terminal through the communications interface; processing said response and identifying the module of the service terminal affected by said response; and interacting with said module by performing an operation in the service terminal.

### FIELD OF THE INVENTION

The present invention relates to the field of telecommunications and, more in particular it refers to the field of service terminals connected to remote servers.

### STATE OF THE ART

Namely, a Point of Sales (POS) is a system which manages the sale process by means of an accessible interface for sellers, but generally speaking the concept POS is applied to any application from which a sales process is provided. Therefore, the following classification can be done:
Complete PC Applications, which Basic functions typically are creating and printing out a receipt, ticket or sale invoice, comprising the detailed references and prices of sold articles, updating the level of stock and goods in the database and allowing the authorization for paying with credit/debit cards which will be afterwards transferred to bank entities.
There could be compact approaches, where all needed elements are integrated in the terminal (CPU, printer, monitor, keyboard) in a unique machine, as well as modular approaches, based in a conventional PC, where different peripherals are connected, together with installed software over a conventional operative system, which allows the use of typical PC functions.
Dataphones, small size devices, based on a reduced keyboard, various types of card reader (magnetic band, smart card, contactless) and an application software which communicates the remote server party.
WebPOS, where access through an internet browser and a web application to the procedures needed to realize the sale is granted, typically charged to a credit/debit card.
mPOS (mobile POS), where the handset turns into the device to perform the sale transactions. Variants of previous cases can be: a webPOS running in the handset or with an added component able to read any kind of card, acting as a dataphone.

Within this classification and focused on dataphones, the current functioning model is that applications run inside the device and when the operation is finished, the transaction data is sent to the server, in order to consolidate data, using for this any data transmission technology.

The outlook of this kind of devices is characterized by the diversity of manufacturers and by the customization of solutions of each manufacturer: they are not open systems over which any one can develop, it is not usual that third parties can develop over POS.

Several initiatives have emerged in order to achieve devices standardization, in such a way that, regardless of the manufacturer, the devices present a common API and developments can be translated in a transparent way from one device to another, from one manufacturer to another, without problems. Among these initiatives it is worth pointing out STIP (Small Terminal Interoperable Platform), from GlobalPlatform [http://www.globalplatform.org/] or UnifiedPOS [http://www.nrf-arts.org/UnifiedPOS/].

STIP is the acronym of Small Terminal Interoperability Platform. The STIP consortium is a group of secure transaction solution providers, which includes device manufacturers, smart card manufacturers and others. It was created to define a Java specification for small size terminals and transaction oriented devices.

FIG. 1 shows the underlying architecture to the STIP technology. Platform 11 exposes, through its software interfaces 15, the interaction capacities that the different elements 13 which compose it have on it, such as the printer, magnetic band reader, the contacless card reader . . . .

One application 12 includes a main element 16 which controls the operation of said application 12, and also a set of intermediate services 14, which permit to interact with the platform 11 and its elements 13.

The presented interfaces 15 both by platform elements 13 and by intermediate services of the application 14, follow an approach in which the services generate events as a response to changes in the state of the components, while the application performs requests to the services 14 in order to control their operation.

The goal of STIP is to specify a software platform which provides the following:
support to many applications of secure transactions in a terminal,
interoperability for the applications being capable of running in a wide range of devices,
a method for managing the application life cycle which can be implemented in devices of small size, with limited resources, something usual in the environment of card devices.

The STIP technology fulfils the former functional requirements by means of the following characteristics:
A common high-level programming language: the basis for interoperability of applications in different hardware platforms is to use a common programming language, regardless of the underlying hardware. The STIP solution relies on the use of objects-oriented languages, such as Java. Furthermore, the STIP technology has defined a sub-set of the most common basis of the Java API in order to provide a common subgroup, which can be used in all platforms, no matter the version of the implemented language.
Definition of the accesses to resources and common peripherals in small terminals in a portable way: the access to all the resources is made by means of service controls.

The main difficulty is to provide a flexible API which permits several configurations of peripherals and, at the same time, which does not commit and even strengthen security and interoperability. The solution lies on the following approach: each possible resource of the platform (peripherals, storage . . . ) is considered as a service, which is implemented by a software library if it is present in the platform. The STIP API does not provide any direct access to these libraries.

On the other hand, an application can only access to a service control interface 15 standardized for each service. In order to access to and use a service, the application must request the opening of a communication channel between the control of the service it manages and the real service hidden behind it.

Besides, in order to obtain an object of service control of a specific type, the application must first request to the services control manager a service control object of the same type. There are certain advantages which show up when this approach is used:
When a particular type of service is not present in a determined platform, it is not needed that the platform implements the related service control. The STIP platform only defines the declaration of the service control interface, but not its implementation. This way, interoperability is possible without sacrifying flexibility.
Applications do not deal with specific service APIs, but with standardized service control APIs. This is important for interoperability, since the libraries can be platform specific, but the interface can be common to all the platforms.
Security is managed in a comfortable way by the platform, since it is not possible to access any resource without two specific requests from the application. These requests are used to obtain the service control instance and to open through this service control a communication channel with the specific service. This way, the implementations of real services are automatically protected by the platform.

Summarizing, STIP satisfies the needs for flexibility, security and interoperability.

The STIP approach is sustained by the systematic use of a programming style based on events. The underlying mechanisms for requesting events are simple, completely specified and independent from the implementation. This improves the programming of applications highly reactive and, at the same time, enforces security and interoperability of applications.

The usual operation model is that the different execution options are located in the application which exists in the device itself, and in order to update the application, it is necessary to perform maintenance, device per device. This maintenance, either if it is done remotely or locally, is necessary for each device and it has some complexity in the updating process and an increase in cost according to the installed plant.

Thus, it is of special interest to simplify the update of applications which are run in the POS terminal. In this line, the chosen way has been to move the logic of applications from the POS terminal to the server, in such a way that instead of connecting to the server only once the transaction is finished, the POS terminal is connected to the server during intermediate steps, in such a way that the POS terminal can be simpler and applications can be implemented with a degree of flexibility that otherwise would not be possible. This is the main idea under U.S. Pat. No. 5,696,909.

Currently, some related approaches have been proposed, which translate the web applications model for Internet to the operation of a POS terminal; this way, the POS terminal becomes a browser, comprising capacities for interpreting a markup language and managing the resources of the device, making download requests of new pages as far as they are needed.

These proposals imply a step forward in the idea of moving the application control to the server, but still present some limitations:

U.S. Pat. No. 5,696,909 establishes a general model based on creating an intermediate element which assumes part of the hardware and software capacities of the POS terminal, and a set of predetermined transactions. This does not actually allow a full control from the server comprising the applications which are run in the POS terminal. Furthermore, the frequent interaction with the server could not be bearable in scenarios where communications issues exist, either because of the performance (times of response), or because of the cost of said communications.

In this aspect, one of the already existent mentioned proposals involves a strong restriction in relation to the POS terminal being capable of interpreting its markup language, which implies an important capacity of computation, resulting in a limitation for basic POS terminals.

### SUMMARY OF THE INVENTION

The main idea of the present invention is to move the logic of applications which runs on a service terminal or a POS terminal, in order for them to be fully controlled by a server. With this purpose, the model is based in STIP, in which each element of the service/POS terminal has an associated module, which controls it and is capable of generating the events corresponding to each change of state.

The operating model is as follows: each event generated by an element of the service/POS terminal, together with all the information associated to the event, is sent to the server for it to determine the next action to perform. As a consequence, the server response will contain the information required by the control modules of each element of the service terminal or TPV for modifying its state when needed.

With this operation model, the complete control of the execution is done at the server, the service terminal or POS terminal being in charge only of capturing the events therein produced, transmitting them to the server and modifying its state as a function of the produced response. This way, the limitations of current solutions are totally overcome.

In a first aspect of the present invention, a method for managing an operation in a service terminal through a remote server is provided. The service terminal comprises a plurality of modules and a communications interface configured for communicating with the remote server, and the remote server comprises a plurality of applications and a communications interface. The method comprises the following steps:
generating an event as a response to a user interaction with one of said modules of the service terminal;
associating an information to said event;
sending said information to the remote server through the communications interface;
processing the received information in the remote server and running an application which obtains a response to the information associated to said event;
sending said response to the service terminal through the communications interface of the remote server;
processing the response and identifying the module of the service terminal affected by said response; and
interacting with said module by performing an operation in the service terminal.

Preferably, the information associated to an event comprises a service terminal identifier, a module identifier for the module which has generated said event and an operation identifier which represents the particular event generated by said module.

This information associated to an event further comprises a plurality of parameters representing additional information data for said event.

The response obtained after running an application in the remote server comprises the following information: a module identifier for the affected module and an operation identifier for the operation which is intended to be performed on said module.

Said response obtained after the execution of an application in the remote server further comprises a plurality of parameters representing additional information data for said operation which is intended to be performed.

The communication interfaces between said service terminal and said remote server are established with any wireless or wired technology.

In a preferred embodiment each one of said plurality of applications comprised in said remote server, is based on a set of states and transitions among said states, based on which a new state is determined as well as an event that is sent as said response to the generated event in the service terminal. And each of said modules comprised in the service terminal is a peripheral module which comprises a control module.

In another aspect of the invention a system, which comprises a plurality of service terminals and a remote server, where the management of operations on each service terminal is performed by the method previously described, is provided.

Finally a computer program comprising computer program code means adapted to perform the steps of the method previously described when said program is run on a computer, a digital signal processor, a field-programmable gate array, an application specific integrated circuit, a micro-processor, a micro-controller, or any other form of programmable hardware is provided.

### BRIEF DESCRIPTION OF THE DRAWINGS

To complete the description and in order to provide for a better understanding of the invention, a drawing is provided. Said drawing forms an integral part of the description and illustrates a preferred embodiment of architecture for implementing the method of the invention, which should not be interpreted as restricting the scope of the invention, but just as an example of how the invention can be embodied.

FIG. 1 illustrates a scheme of the architecture of a STIP technology point of sale.

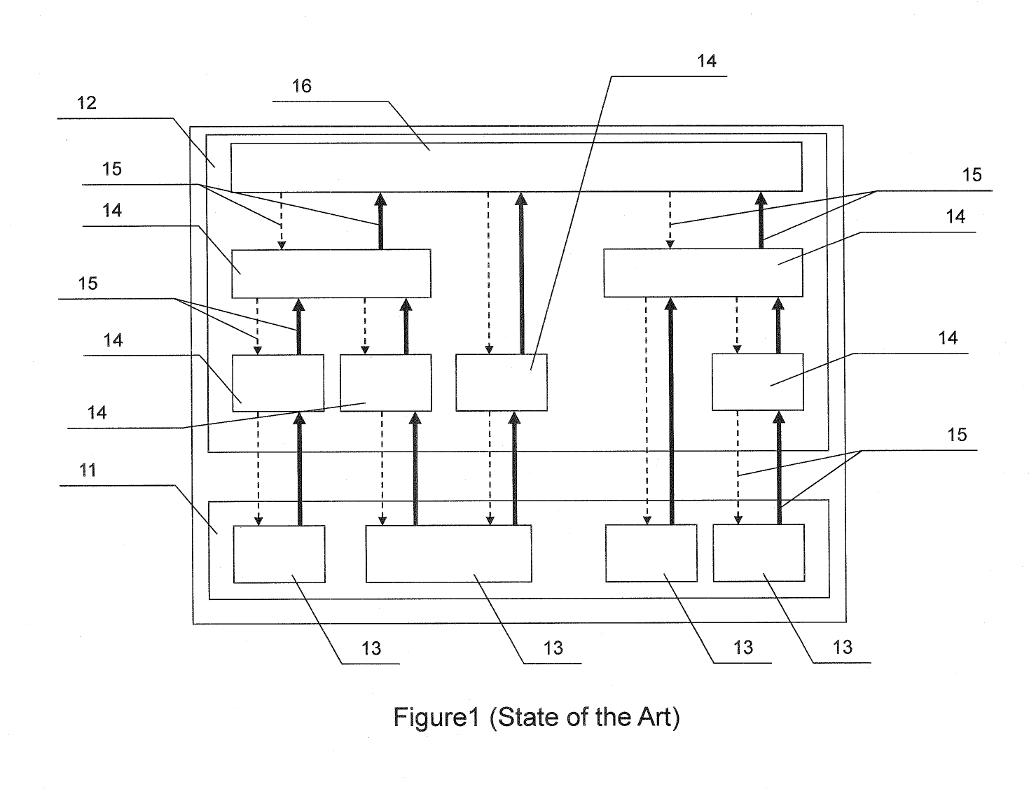

FIG. 2 illustrates a scheme of the architecture of a point of sale terminal and a remote server, according to an embodiment of the present invention.

### DETAILED DESCRIPTION OF THE INVENTION

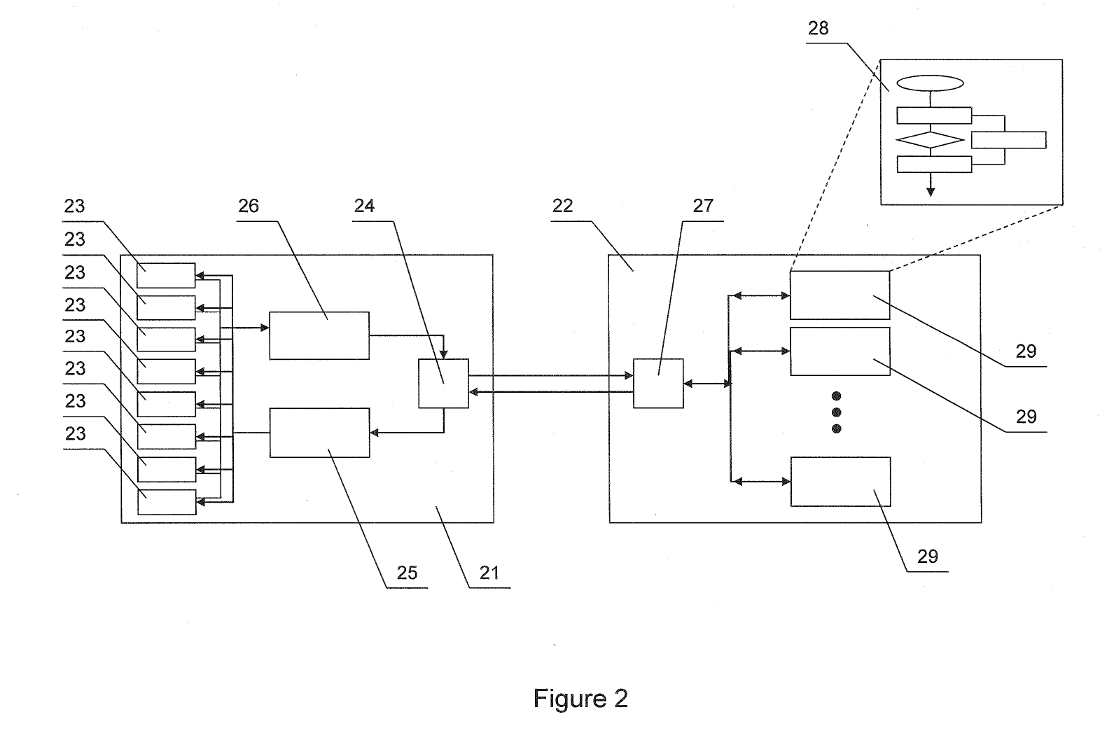

FIG. 2 illustrates a scheme of the architecture of an embodiment of the invention. More specifically, in FIG. 2 a service terminal or point of sale terminal 21 and a remote server 22 are represented.

According to the Small Terminal Interoperability Platform (STIP), it is possible to represent a service terminal or point of sale terminal (POS) 21 as a set of modules 23, each of them having a control element and an element for managing the events. Non-limitative examples of modules which can be included in a POS terminal 21 are: contactless card reader, light emitting diodes, magnetic card readers, Smart Card Slot, keyboard, printer, user interfaces, beeper, transport card, Card Holder Verification, communications, cryptography, date, power supply, timer, file, http, http server and XML.

It can be observed that the service terminal or point of sale terminal 21 also comprises a communications interface 24 configured for communicating with the remote server 22, that is, for managing the communications with it. FIG. 2 also shows a control module 25, for interacting and controlling the modules 23 of the POS terminal 21, and an element 26 for capturing and managing the events generated by the modules. These two elements 25 26 are associated to each of the modules 23.

Meanwhile, the server 22 hosts an element or interface 27 for managing the communications with the service/POS terminal 21. Besides, the server 22 comprises the logic 28 of all the applications 29 which are to be run on the server. Thus, the server 22 hosts different applications 29, wherein each of them implements it own algorithm, allowing for total flexibility.

When an application 29 receives a new event, it determines which response event it must generate. In order to do this it relies on a set of states and transitions: each application 29 creates the states that it considers necessary and the transitions between those states. Depending on the state of the application 29 and on the received event, a new state and the event which is to be sent to the service/POS terminal 21 are determined.

As a consequence, for each service/POS terminal 21, instances of an application 29 are created at the server 22, in order to store the state of the application 29; that is to say, apart from controlling the algorithm which defines the operation of an application 29, together with its possible states and transitions, the state of an application 29 for a particular service/POS terminal 21 is controlled.

This way, the proposed method for managing an operation in a service terminal or point of sale terminal 21 comprises the following steps:

First, when a user makes any type of interaction with any of the modules 23 which are part of the service terminal or POS terminal 21, an event is generated, which is captured by the element for managing the events 26. For example, if a key is pressed or if a card is slid at the card reader.

Next, the element for managing the events 26 characterizes the event, associating certain information to it. Preferably, this information comprises a peripheral/module identifier 23 of the POS terminal 21 to which it belongs or from which it comes, a service/POS terminal 21 identifier to be able to discriminate the POS terminal 21 which is being invoked and an operation identifier which represents the particular event generated by the module 23 (each module 23 or peripheral can generate different types of events). If necessary, it also comprises parameters or additional data corresponding to the captured event, specific for said event. For example, the data read from the card.

Afterwards, making use of the communications element or interface 24, that information is sent to the remote server 22. In order to establish this communication, any wired or wireless technology can be used.

Next, the communications element or interface 27 of the server 22 processes the received information and, depending on the POS terminal 21 which originated the request, it retrieves the corresponding application 29 which is executed in said service/POS terminal 21; this application 29, which contains a particular logic of application 28, receives the information of the generated event at the POS terminal 21 and, according to the identifier of the module 23, the additional data if there were any and the state of the application 29, obtains a response to the information associated to the event, determining which the next step to be performed at the POS terminal 21 is. This step is defined in terms of an operation to be done on any of the modules 23 of the POS terminal 21.

Making use of the communications elements or interfaces 27 24, this response is sent from the server 22 to the POS terminal 21. Preferably, this information comprises: a module identifier 23, which represents the affected peripheral; an operation, which represents the particular operation which is intended to be performed on said peripheral, from the control element (on each peripheral different types of operations can be generated) and, if necessary, parameters of the operation, which represent particular additional data of the operation to be performed.

At the POS terminal 21 this information is processed and the module 23 affected by the operation to be executed is identified, as well as the possible parameters which have an influence on that operation.

Finally, the control module 25 is in charge of interacting with the module 23, triggering the operation which has been determined at the server 22.

This method permits that, making use repeatedly of these steps, any application 29 can be defined with absolute control of its behaviour from the server 22.

In summary, architecture and a method are proposed, which allow total flexibility in the definition of applications which are executed at a POS terminal 21, avoiding software modification issues at the POS terminal 21.

The proposed architecture is totally generic, relying on the events generation and control elements over peripherals, permitting the incorporation of ad-hoc peripherals which are required for each scenario.

Besides, since each event of each peripheral is processed at the server 22, an absolute control of the operation which is to be executed at the POS terminal 21 is allowed. It is worth to stress that this way, a total customization is achieved for each TPV 21: it can be considered that each POS terminal 21 or group or POS terminals can have a particular configuration, having different operations from those of other POS terminals 21 or groups of POS terminals. The flexibility is total.

Another advantage, consequence of having the control of the application 29 at the server 22, is that the applications can be connected to external systems to retrieve values or to perform transactions that would be difficult to perform from the POS terminal 21 itself, which is particularly interesting in the case of financial applications and, in general, for commercial platforms.

1. A method for managing an operation in a service terminal (21) through a remote server (22), wherein said service terminal (21) comprises a plurality of modules (23), and a communications interface (24) configured for communicating with said remote server (22), wherein said remote server (22) comprises a plurality of applications (29) and a communications interface (27),
the method being characterized by the following steps:
generating an event as a response to a user interaction with one of said modules (23) of the service terminal (21);
associating an information to said event;
sending said information to the remote server (22) through said communications interface (24);
processing said received information in the remote server (22) and running an application (29) which obtains a response to the information associated to said event;
sending said response to the service terminal (21) through the communications interface (27);
processing said response and identifying the module (23) of the service terminal (21) affected by said response; and
interacting with said module (23) by performing an operation in the service terminal (21).

2. The method of claim 1, wherein said information associated to an event comprises: a service terminal (21) identifier, a module identifier for the module (23) which has generated said event and an operation identifier which represents the particular event generated by said module (23).

3. The method of claim 2, wherein said associated information further comprises a plurality of parameters representing additional information data for said event.

4. The method of claim 1, wherein said response obtained after running an application (29) in said remote server (22) comprises the following information: a module identifier for the affected module (23) and an operation identifier for the operation which is intended to be performed on said module (23).

5. The method of claim 4, wherein said response obtained after running an application (29) in said remote server (22) further comprises a plurality of parameters representing additional information data for said operation which is intended to be performed.

6. The method of claim 1, wherein said communication interfaces (24, 27) between said service terminal (21) and said remote server (22) are established with any wireless or wired technology.

7. The method of claim 1, wherein each one of said plurality of applications (29) comprised in said remote server (22), is based on a set of states and transitions among said states, based on which a new state is determined as well as an event that is sent as said response to the generated event in the service terminal (21).

8. The method of claim 1, wherein each of said modules (23) comprised in said service terminal (21) is a peripheral module which comprises a control module (25).

9. A system which comprises a plurality of service terminals (21) and a remote server (22), where the management of operations on each service terminal (21) is performed by the method of claim 1.

10. A computer program comprising computer program code means adapted to perform the method according to claim 1 when said program is run on a computer, a digital signal processor, a field-programmable gate array, an application specific integrated circuit, a micro-processor, a micro-controller, or any other form of programmable hardware.
